(19) United States
(12) Patent Application Publication
(10) Pub. No.: US 2005/0246270 A1
(43) Pub. Date: Nov. 3, 2005

(54) Method of maximizing real estate capital interests

(76) Inventor: Martin I. Goodman, San Diego, CA (US)

Correspondence Address: SAM TALPALATSKY, 10867 CLOVERHURST WAY, SAN DIEGO, CA, 92130, US

(21) Appl. No.: 10/836,950

(22) Filed: Apr. 30, 2004

(51) Int. Cl. G06F 17/60

(52) U.S. Cl. 705/39

(57) ABSTRACT

Under threat of foreclosure or after notice of trustee sale, a single entity provides a property owner the option of selling the property, listing the property for sale or borrowing money secured by such property. Further embodiments disclose a method of researching the property profile in advance to allow the property owner to avoid foreclosure in a time sensitive situation. Another embodiment of the invention removes the threat of foreclosure or foreclosure proceedings by structuring a loan that is used to satisfy current obligagtions and further applies such loan proceeds to repair the property making it marketable.

### FIELD OF THE INVENTION

The present invention relates to a novel method of maximizing capital returns related to real estate interests.

### BACKGROUND OF THE INVENTION

Real estate investments are some of the most seasoned vehicles to wealth. Over the years many professions evolved to service real estate needs. Lenders specialize in raising and lending substantial capital to real estate owners and buyers, who in return secure the loan with their real estate interests. Real estate loan brokers evolved to facilitate the lending process by soliciting, qualifying and bring the real estate owners and lenders together. Real estate sales professionals specialize in bringing together potential buyers and sellers of real estate interests. Thereafter or congruent therewith, if an exchange or a business relationship is desired, a loan broker customarily gets involved to finance the transaction. This conventional circle is highly effective, but at the same time it is inherently burdened with inefficiencies of dealing with two or three different professionals, each having its own delays and interests.

The need for efficiency and flexibility is further amplified by foreclosure proceedings. Often a real property owner, especially in states that implement non-judicial foreclosures, has a short period of time to restructure his debt or sell the property to capture his/her equity or to retain his/her interests. Dealing with two or more real estate professionals to manage the options of borrowing money, restructuring debt or offering the property for sale are at the very least time consuming and complex. More often than not, the person needing these services is not educated in the relatively complex arts of real estate transactions or lacks sufficient resources to make the best decision and avoid foreclosure. Real estate professionals who do not offer all three services are not motivated to provide the owner with the best alternative, or are simply unable to do so because they do not understand that field, do not have time to engage another party, or simply have no incentive to do it. At the end, under pressure of time and in a charged, emotional state of a complex personal and financial position, the owner may lose his real estate interests in the foreclosure because the remedy was not available from a single source.

Thus, there remains a need for a single real estate entity to integrate at least the three common real estate disciplines: namely, the services of lending money secured by real property interests, purchasing real property and listing real property.

### SUMMARY OF THE INVENTION

The present invention provides a method of integrating at least three common areas real estate disciplines in a single source: namely, the services of lending money secured by real property interests, purchasing real property and listing real property for sale, wherein such property is under threat of foreclosure or in foreclosure.

In one embodiment of the invention, the single entity receives a list of properties under threat of foreclosure. At that time, the entity researches the property by pulling a preliminary title report, appraising the property, searching liens recorded against the property and otherwise completing the research necessary to determine whether there is enough equity in the property to avoid foreclosure. Then, the entity contacts the property owner and discusses the options with him/her.

One of such options is for the property owner to sell the property to the entity and to pay off the debt secured by such property with the sales proceeds. This option avoids a significant stain on the property owner's credit rating and it often results in other benefits such as capturing residual equity, ability to rent the property from its new owner, or perhaps the ability of living in a home on terms that are significantly better than a likely eviction in the foreclosure process executed by law enforcement officials.

Another option is to borrow money secured by the real property and to use the proceeds of the loan to pay the foreclosing entity thereby extinguishing the threat or certainty of foreclosure. Such loans are usually unconventional, as they are inherently risky. This loan could be a bridge in time to future income or simply restructure of the property owner's debt. The loan is then repaid and the property owner often tries to refinance the loan with a more conventional one to reduce his/her costs.

Another option is to borrow money secured by the real property and using the proceeds of the loan to pay the foreclosing entity, thereby extinguishing the threat or certainty of foreclosure. Once the threat of foreclosure is extinguished, the property is listed for sale, often through the MLS (multiple listing service). The proceeds of the sale then repay the outstanding liens, loan principal, interest, fees and costs. In other cases, the proceeds are also used to make necessary repairs to the property. Accordingly, the property owner is able to satisfy his/her obligations without losing the property, is often provided the extra time to move, and often is able to capture some residual equity out of the property net of the costs of the transaction.

Because, as described above, the single entity has the background on the property that received a notice of default, i.e. threat of foreclosure, or is in foreclosure, the procrastinating or time-challenged property owner has the option of choosing from one or more of the options above on shorter notice, which is not customarily available from any other entity because such entity did not have the time necessary to research the equity position, liens, appraisals or title. Again, the property owner benefits from controlling the situation as described above.

Other methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

FIG. 1 is a flowchart illustrating the prior practices of lending, listing or buying institutions.

FIG. 2 is a flowchart illustrating an exemplary embodiment of the present invention, where a single entity provides the services of listing, or buying or listing the property in threat of foreclosure or lending money secured by such property.

FIG. 3 is a flowchart illustrating an exemplary embodiment of the present invention, where the single entity researches the dynamics of the properties under the threat of foreclosure or in foreclosure and lends money secured by such property and lists such property; thereafter applying the proceeds of the sale to satisfy the liens secured by the property, loan, interest and fees of the transaction.

FIG. 4 is a flowchart illustrating an exemplary embodiment of the present invention, where a single entity provides the services of lending money secured by a property in threat of foreclosure and repairing the property using such loan proceeds; the property thereafter is refinanced or sold to satisfy the liens secured by the property, loan, interest and fees of the transaction.

The foregoing Figures, flowcharts therein and the specification are equally applicable to properties under threat of foreclosure or in foreclosure.

### DETAILED DESCRIPTION OF THE INVENTION

The disclosed embodiments describe methods of providing, through a single entity, a property owner with options to maximize his/her capital interests in a property that is either in threat of foreclosure (i.e. receipt of notice of default, notice of delinquency, notice of intent to foreclose, or the like) or in foreclosure (notice of trustee sale or the like).

By way of background, a property owner may accrue either voluntarily or involuntarily a number of liens that are secured by his/her property interests. Such liens are customarily recorded in the public records against the property. If in accordance with the underlying lien, such as a loan, the property owner does not satisfy his/her obligations, such as repayment of the secured loan, the lien holder customarily sends a notice of delinquency to property holder. This notice signals that further, serious steps are on the horizon that would likely lead to foreclosure of the property to satisfy the obligations secured by the lien and the property. To extinguish such threat, the property owner could satisfy the obligations owed to the lien holder or seek judicial intervention. If however, the property owner does not timely extinguish the obligations giving rise to the notice of delinquency, a public notice of default is sent to the property owner. Again, if the property owner does not take steps to extinguish the obligations giving rise to such default, the lien has the option of foreclosing on the property. This next step is initiated by sending a public notice of trustee sale, indicating that foreclosure proceedings are in motion. Such proceedings will lead to the foreclosure and loss of property rights, which will be sold to satisfy the secured obligations.

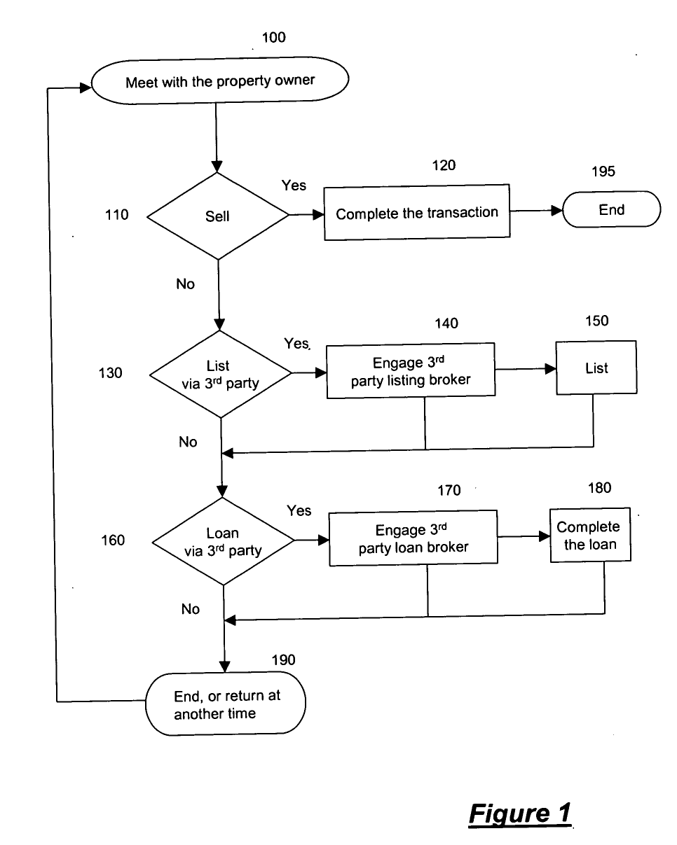

FIG. 1 illustrates the conventional method of providing a property owner with options either under threat of foreclosure or in foreclosure. Customarily, a buyer primarily interested in purchasing the property meets with the owner, 100. The buyer usually offers to purchase the property 110 for some amount equal to or greater than the liens recorded against the property, but at a discount to the market price. This proposition is predicated on the analysis that the property owner does not have sufficient time or resources to market the property in light of the threat of foreclosure or foreclosure proceedings. As such, the property owner has the option of reaching the likely certainty of losing the property through foreclosure, but instead of the negative implications of foreclosure, he/she could walk away from the property and at times receive some proceeds of the residual equity by selling the property at a discount to the buyer.

As further illustrated in FIG. 1, the property owner may expect a better price for his/her property and therefore a greater return of the equity then offered by the approaching buyer. Therefore, he/she may want to list the property through the MLS (multiple listings service) or otherwise offer it for sale in the general market, 130. Often, the original buyer that approached the property owner is not a real estate broker and therefore cannot offer such a service. In that case the buyer has to involve another entity that could offer such a service to the property owner, 140. Yet in other instances, the property owner has to seek a broker, 140. Such arrangements often lead to further and inherent delay and complexity, as additional entities become involved in the transaction. If the property owner is satisfied with the proposed structure, he/she lists the property, 150, where it is offered for sale to the general market.

Additionally, to realize the time such sale requires, the property owner has to satisfy the outstanding obligations that threaten or have triggered the foreclosure proceedings. To do so, the property owner has to qualify and secure a loan. Again, in a typical situation, a real estate broker or yet another third party lender gets involved, 160, 170 and 180. As before, involving another party or multiple parties, 170, involves inherent additional complexities and time delays, 170 and 180. Often the property owner is under time pressure to structure a deal prior to the foreclosure of the property and such complexities and time delays work against him/her or make the deal unworkable. It is also often the case that the property owner does not take timely action, 190, in which event, the cycle is either completed and the property would likely be foreclosed, or be restarted again at 100, with less time to resolve the problem. Again, with multiple parties involved in structuring the transaction, the likelihood of success of the transaction under time, varying scope of scrutiny of multiple parties, and appeal of the transaction to the lender, buyer or broker, all diminish the likelihood of success of the transaction outlined in steps 100-190 of FIG. 1.

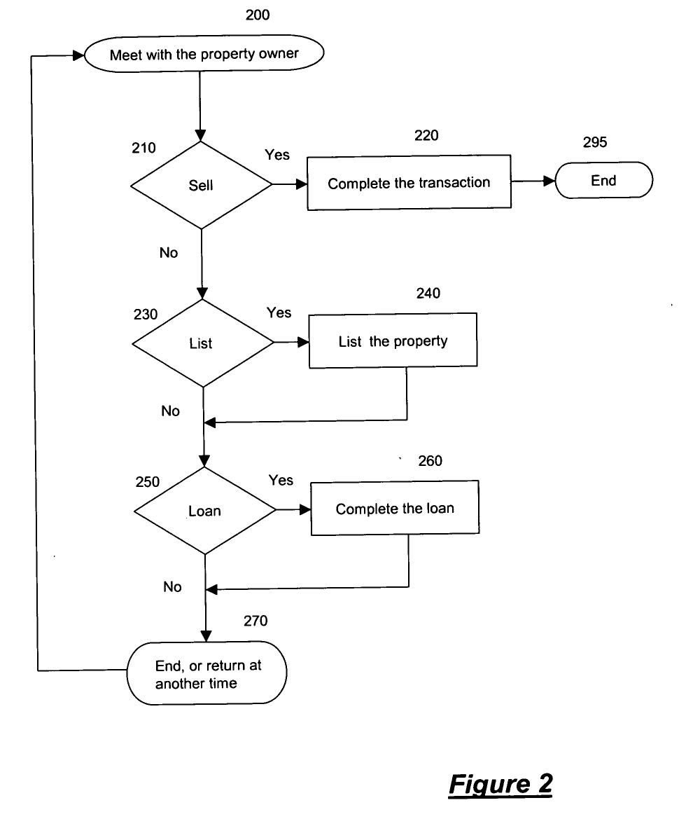

FIG. 2 is a flow chart one of the embodiments of the present novel method. A single entity meets with the property owner, 200, offering the property owner the options of selling the property, 210, or listing the property for sale on the market, 230, and/or providing the property owner with a loan, 250. The aforementioned inefficiencies, delays and complexities of bringing in third parties are thereby removed. More particularly, the property owner contacts the single entity after receiving a notice of delinquency from one or more lien holders secured by the real property, or the single entity learns that the property owner received a notice of default and that his/her property is at risk of foreclosure. That almost always signals a property owner's financial distress. The single entity performs a property profile and determines whether enough equity exists in the property to structure a deal to forego the foreclosure. One option is to purchase the property from the property owner, 210, and use the proceeds of the sale to satisfy the foreclosing party, the costs of the deal and at times provide the property owner with the remainder of the equity. This option, 210, is superior to the foreclosure, as the property owner retains higher integrity in his/her credit rating, leaves the property at his/her schedule, is often able to rent back the property instead of moving, and at times leaves with some money. If this is the option that the property owner takes, the entity completes the transaction, 220 and 295.

In the alternative, if the property owner is not willing to sell, 210, or if the options of listing the property for sale, 230, or restructuring his/her debt, 250, is a better alternative, the single entity could offer such options without involving a third party. It may be the case that the property owner prefers to list the property for sale through some of the common channels such as the MLS. Selling the property this way usually realizes a better price brings in more dollars for the property, but it also usually takes more time. If so, the single entity lists the property, 240, and represents the property owner in such sale. The proceeds of sale are then applied to satisfy the lien holders and the property owner retains the remainder of such proceeds, 270.

Often, however, the property owner is not able to list the property, 230, because of the time constraints involved in the fast moving non-judicial foreclosure process. Accordingly, the property owner needs a bridge loan, 250, to satisfy the demands of the foreclosing lien holder while the property is offered for sale, 230. As mentioned above, in the past this step involved multiple parties and such multi-party transactions created long, expensive, complex and inefficient layers to the transaction, often derailing the deal and leaving the property owner without a remedy to the foreclosure proceedings, or in the alternative, forcing the property owner to sell, 110, 120, 195. In the disclosed method, however, a single entity offers all three services, 210, 230 and 250. Namely, a single entity, without the inefficiencies of the prior art, is able to offer to the property owner a loan, 250, complete the loan, 260, and in whole or part apply the proceeds of the loan to satisfy his/her current obligations. This terminates the threat of foreclosure or foreclosure proceedings and provides the property owner with enough time to list the property, 240, and realize the maximum return of his/her equity. After the sale, the proceeds are applied to satisfy the loan and other liens against the property and the remainder is distributed to the property owner.

The ability to offer the three services, 210, 230 and 250, through a single entity is even more relevant in a time sensitive situation. It is often the case that the property owner initially rejects the offers described above, either by multiple entities, as shown in FIG. 1, or a single entity as shown in FIG. 2. The threat of foreclosure starting with the notice of default then progresses to fast moving foreclosure proceedings. Often property owners wait until a few days or even a day prior to the foreclosure to realize the inevitable and at that point decide to salvage their equity in the property or take steps to stay the foreclosure. Using the conventional method shown in FIG. 1, often denies the property owner the remedies described above, simply because it is difficult or impossible to structure such transactions on a short notice because too many individuals, contracts, details and schedules are involved.

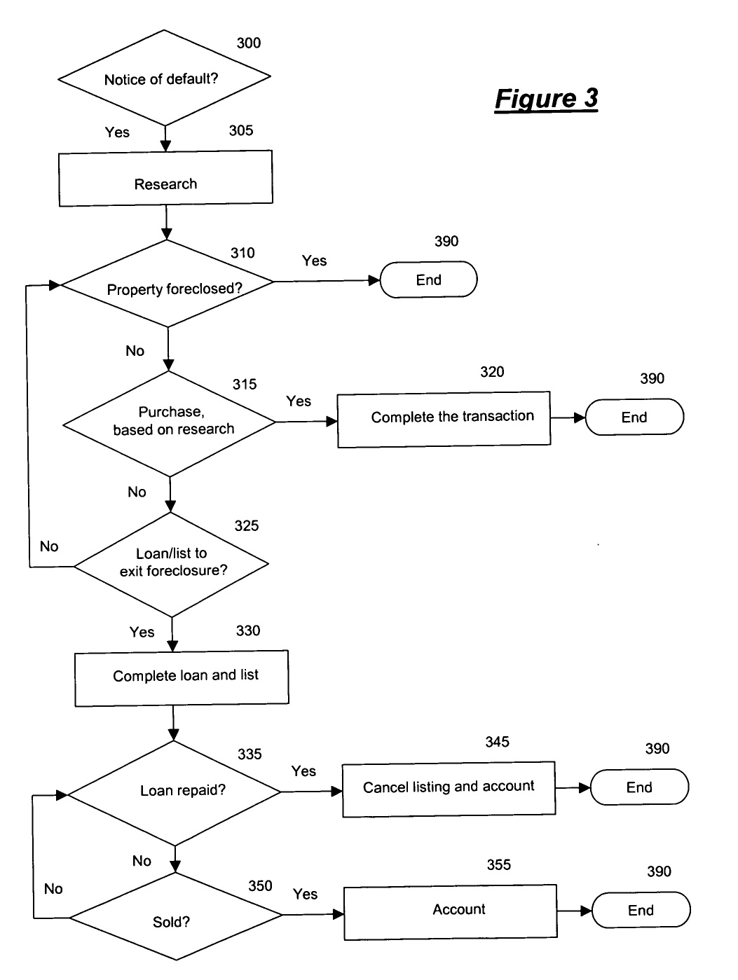

Flowchart of FIG. 3 illustrates a novel method of property profiling and loaning money to property owners at risk of foreclosure or in foreclosure, 300. The single entity learns that one or more properties received a notice of default or notice of trustee sale. The single entity then profiles such properties to determine which ones satisfy its internal guidelines to qualify for a loan. As one example, through the databases available to the public, the single entity could find out the size of the property improvements, the average price per square foot in that area, calculate the total and factor the risk/discount into that price. If the recorded liens are below that price, the property becomes a candidate to the single entity. Through this study, the single entity qualifies a list of properties that are at risk of foreclosure and begins its research, 305. The research for one or more properties on the list includes, but is not limited to one or more of: a curbside appraisal of the property, lien search, tax search, and updating the title search on the property. As will be explained below, this diligence becomes vital in structuring a loan and saving the property from foreclosure when the property owner decides to avoid foreclosure “at the last hour.”

As described above, if the property is not yet foreclosed 315, the single entity approaches the property owner and provides him/her with the three options of selling the property 315, listing the property, 325, or borrowing money to avoid foreclosure, 325. It is often the case that the property owner does not take constructive steps after receiving a notice of delinquency or notice of default to avoid the fast-moving foreclosure proceedings. In that case, the single entity may approach the property owner at a later time, 310, and once again provide him/her with the options of selling, 310, listing, 325, or borrowing money, 325, to avoid foreclosure. At some point the property owner avoids the foreclosure through his/her own means or the property is foreclosed, at which time the single entity no longer approaches the property owner, 390. However, as the inevitable foreclosure gets closer and closer, the property owner often elects to choose one or more of the options of selling 310, listing or borrowing money, 325, just a few days and sometimes hours before the foreclosure proceedings. If the property owner decides to sell the property to the single entity, 315, single entity is capable of completing the transaction, 320, with very little notice because of the research, 305, it did prior to the decision. Conversely, if the single entity did not make the investment, 305, prior to approaching a number of property owners, it would not have enough time to close the transaction. As an example, a title insurance company could not research the property within a few hours notice.

Similarly to the method described in FIG. 2, the property owner may choose not to sell the property to the single entity because selling it on the open market would likely realize a higher price. To do so with little notice or time the single entity structures a loan based in part on the prior research, 305. The structure takes into account the available equity in the property and average time to sell similar properties. The loan contract may provide for a lower level of repayment or no payments while the property is listed. In another embodiment the loan contract may provide for equity sharing. Yet in another embodiment the property owner has the option of satisfying the loan and terminating the listing. Many other combinations exist as well to tailor each situation to its needs and facts. However, in all of such embodiments the prior research/diligence, 305, allows the single entity ability to meet the property owner's needs on a short notice and avoid foreclosure. It is also the case, as before, that providing such options and services through a single entity often makes the process possible in a time sensitive situation.

The loan proceeds are used to satisfy one or more obligations that triggered the foreclosure threat or proceedings. In some cases, some amount over the current obligations recorded against the property may be provided to the property owner as well. At about the same time, the property is listed for sale, 325, in the MLS. When the property is sold, 350, the proceeds are used to satisfy the loan, accrued interests, fees and costs, 355. If the property owner is able to repay the loan, accrued interest, fees and costs 335, he/she can do so and at the same time, depending on the contractual obligations, remove the property from the MLS, 345, and end the transaction, 390.

The reader will appreciate that the aforementioned method of researching property profiles that are at risk of foreclosure or in foreclosure could be combined with any of the options described in this disclosure.

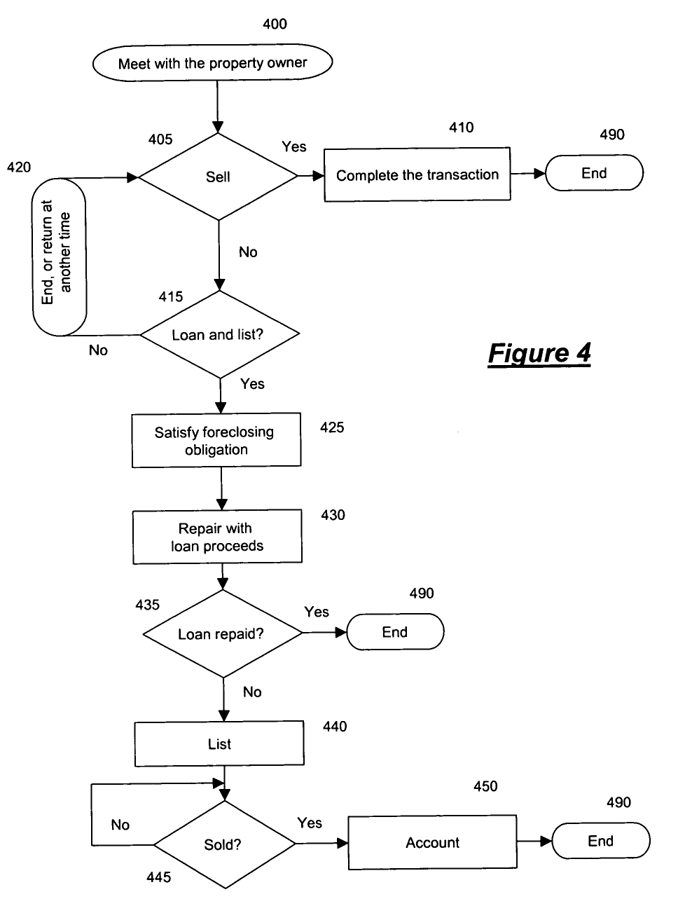

Flowchart of FIG. 4 illustrates a novel method of providing a property owner with a loan, the proceeds of which are then used to repair the property to bring it to a marketable condition. The single entity meets with the property owner 400 whose property interests are at risk of foreclosure or in foreclosure. At that time the single entity provides the property owner the options described above. If the property owner decides to sell his property to the single entity, 405, they complete the transaction 410, 490. If the property owner does not want to move forward with the options offered by single entity, the process is over or the parties could elect to resurrect the process at a later time 420. If the property owner elects to move forward and try to realize a higher selling price, the parties structure a loan (as described above), 415. The proceeds of the loan are in part applied to extinguish the threat of foreclosure or foreclosure, 425. Another part of the loan proceeds is used to repair or improve the property to make it marketable, 430. Then or concurrently therewith, the property is listed in the MLS, 440. Depending on the contract negotiated between the single entity and property owner, the loan could be repaid by the property owner, 435, and the process ends, 490. Otherwise the property is repaired or improved and when it sells, 445, the proceeds are used to satisfy the loan, interest, fees, repairs, liens and the like, 450. Remainder of the proceeds is distributed to the property owner, 450. In one embodiment of the process at 415, the loan terms provide for lower or no payments by the property owner in anticipation of the sale of the property, at which time the loan and its obligations are repaid.

It is to be understood that for business, tax or liability reasons a business may be structured or organized as one or more legal entities. Therefore the reader will recognize that the term “single entity” used throughout this specification applies to a single legal entity as well as one or more legal entities, where the representative or agent of one or more of such entities has the authority to represent and make decisions for all of such entities.

The aforementioned methods were described in the context of real property transactions. However, similar method could be employed for personal property or other marketable properties. It is also recognized that property ownership, and particularly real property ownership, is a collection of many rights, such as long-term leases, as one example. It will be apparent to those of ordinary skill in the art that many more embodiments, equivalents and implementations are possible that are within the scope of this invention. The described embodiments are provided by way of example and are not intended to limit the invention.

1. A method of maximizing financial options to at least one holder of at least one property interest, wherein said property interest is at risk of a foreclosure or in foreclosure, the method comprising: a single entity providing to the holder at least one of the options of: (a) offering said at least one of the property interest for sale; (b) obtaining a loan secured by said at least one of the property interest; and (c) selling said at least one of the property interests.

2. A method of maximizing financial options as claimed in claim 1, wherein said at least one property interest is in real property.

3. A method of maximizing financial options as claimed in claim 1, wherein said at least one property interest is in chattel property.

4. A method of maximizing financial options as claimed in claim 1, wherein the foreclosure proceedings are judicial.

5. A method of maximizing financial options as claimed in claim 1, wherein the foreclosure proceedings are non-judicial.

6. A method of maximizing financial options as claimed in claim 1, wherein said loan is based on at least one of a: (a) credit worthiness of the holder of interest; (b) income of the holder of interest; and (c) future income of the holder of interest.

7. A method of maximizing financial options as claimed in claim 1, wherein a collateral secures the loan.

8. A method of maximizing financial options as claimed in claim 7, wherein the collateral is at least a real property interest at risk of foreclosure.

9. A method of maximizing financial options as claimed in claim 7, wherein the collateral is at least the income of the holder.

10. A method of maximizing financial options as claimed in claim 1, wherein said risk of foreclosure comprises a notice of delinquency.

11. A method of maximizing financial options as claimed in claim 1, wherein said risk of foreclosure comprises a notice of default.

12. A method of maximizing financial options as claimed in claim 1, wherein said foreclosure comprises a notice of trustee sale.

13. A method of maximizing financial options to at least one holder of at least one property interest, wherein said property interest is at risk of a foreclosure or in foreclosure, the method comprising the step of: a single entity providing to the holder at least one of the options of: (a) offering said at least one of the property interest for sale; (b) obtaining a loan secured by said at least one of the property interest; and (c) selling said at least one of the property interests.

14. A method of maximizing financial options as claimed in claim 13, wherein said at least one property interest is in real property.

15. A method of maximizing financial options as claimed in claim 13, wherein said at least one property interest is in chattel property.

16. A method of maximizing financial options as claimed in claim 13, wherein the foreclosure proceedings are judicial.

17. A method of maximizing financial options as claimed in claim 13, wherein the foreclosure proceedings are non-judicial.

18. A method of maximizing financial options as claimed in claim 13, wherein said loan is based on at least one of a: (a) credit worthiness of the holder of interest; (b) income of the holder of interest; and (c) future income of the holder of interest.

19. A method of maximizing financial options as claimed in claim 13, wherein a collateral secures the loan.

20. A method of maximizing financial options as claimed in claim 19, wherein: the collateral is at least said at least one property interest; said property is real property; and said collateral is at risk of foreclosure.

21. A method of maximizing financial options as claimed in claim 19, wherein the collateral is at least the income of the holder.

22. A method of maximizing financial options as claimed in claim 13, wherein said risk of foreclosure comprises a notice of delinquency.

23. A method of maximizing financial options as claimed in claim 13, wherein said risk of foreclosure comprises a notice of default.

24. A method of maximizing financial options as claimed in claim 13, wherein said foreclosure comprises a notice of trustee sale.

25. A method of maximizing financial options to at least one holder of at least one real property interest, wherein said property is at risk of a foreclosure or in foreclosure, the method comprising: providing said at least one holder with a money loan at least during a listing period, wherein a single entity is providing the loan and listing said at least one real property interest for sale; interest on said loan reduced or eliminated until the property is sold and proceeds of the sale are realized; said loan and said interest on said loan payable to the single entity upon or after the sale of said at least one property interest.

26. A method of maximizing financial options as claimed in claim 25, wherein said at least one property interest is in at least one stage of foreclosure proceedings.

27. A method of maximizing financial options as claimed in claim 25, wherein the foreclosure proceedings are judicial.

28. A method of maximizing financial options as claimed in claim 25, wherein the foreclosure proceedings are non-judicial.

29. A method of maximizing financial options as claimed in claim 25, wherein a collateral secures the loan.

30. A method of maximizing financial options as claimed in claim 29, wherein: the collateral is at least said at least one real property interest.

31. A method of maximizing financial options as claimed in claim 29, wherein the collateral is at least the income of said at least one holder of said at least one real property interest.

32. A method of maximizing financial options as claimed in claim 25, wherein said risk of foreclosure comprises a notice of delinquency.

33. A method of maximizing financial options as claimed in claim 25, wherein said risk of foreclosure comprises a notice of default.

34. A method of maximizing financial options as claimed in claim 25, wherein said foreclosure comprises a notice of trustee sale.

35. A method of maximizing financial options to at least one holder of at least one real property interest, wherein said property is at risk of a foreclosure or in foreclosure, the method comprising the steps of: providing said at least one holder with a money loan at least during a listing period, wherein a single entity is providing the loan and listing said at least one real property interest for sale; interest on said loan reduced or eliminated until the property is sold and proceeds of the sale are realized; said loan and said interest on said loan payable to the single entity upon or after the sale of said at least one property interest.

36. A method of maximizing financial options as claimed in claim 35, wherein said at least one property interest is in at least one stage of foreclosure proceedings.

37. A method of maximizing financial options as claimed in claim 35, wherein the foreclosure proceedings are judicial.

38. A method of maximizing financial options as claimed in claim 35, wherein the foreclosure proceedings are non-judicial.

39. A method of maximizing financial options as claimed in claim 35, wherein a collateral secures the revolving line of credit.

40. A method of maximizing financial options as claimed in claim 39, wherein the collateral is at least the real property interests at risk of foreclosure.

41. A method of maximizing financial options as claimed in claim 39, wherein the collateral is at least the income of the holder.

42. A method of maximizing financial options as claimed in claim 35, wherein said risk of foreclosure comprises a notice of delinquency.

43. A method of maximizing financial options as claimed in claim 35, wherein said risk of foreclosure comprises a notice of default.

44. A method of maximizing financial options as claimed in claim 35, wherein said foreclosure comprises a notice of trustee sale.

45. A method of maximizing financial options to at least one holder of at least one property interest, wherein said property is in disrepair and at risk of foreclosure or in foreclosure, the method comprising: providing said at least one holder with a money loan, said money loan used at least in part to settle said foreclosure, and at least in part to repair said property.

46. A method of maximizing financial options to at least one holder of property interests as claimed in claim 45, further comprising: repairing said property thereby making it suitable for listing.

47. A method of maximizing financial options to at least one holder of property interests as claimed in claim 45, further comprising: listing the property for sale.

48. A method of maximizing financial options to at least one holder of property interests as claimed in claim 45, further comprising: repairing said property thereby making it suitable for listing and listing the property for sale.

49. A method of maximizing financial options to at least one holder of property interests as claimed in claim 45, further comprising: recording a note secured by said property.

50. A method of maximizing financial options to at least one holder of property interests as claimed in claim 45, wherein a single entity is providing said money loan and said listing.

51. A method of maximizing financial options as claimed in claim 45, wherein said risk of foreclosure comprises a notice of delinquency.

52. A method of maximizing financial options as claimed in claim 45, wherein said risk of foreclosure comprises a notice of default.

53. A method of maximizing financial options as claimed in claim 45, wherein said foreclosure comprises a notice of trustee sale.

54. A method of maximizing financial options to at least one holder of property interests, wherein said property is in disrepair and at risk of foreclosure or in foreclosure, the method comprising the step of: providing said at least one holder with a money loan, said money loan used at least in part to settle said foreclosure, and at least in part to repair said property.

55. A method of maximizing financial options to at least one holder of property interests as claimed in claim 54, further comprising the step of repairing said property thereby making it suitable for listing.

56. A method of maximizing financial options to at least one holder of property interests as claimed in claim 54, further comprising the step of listing the property for sale.

57. A method of maximizing financial options to at least one holder of property interests as claimed in claim 54, further comprising the step of repairing said property thereby making it suitable for listing and listing the property for sale.

58. A method of maximizing financial options to at least one holder of property interests as claimed in claim 54, further comprising the step of recording a note secured by said property.

59. A method of maximizing financial options to at least one holder of property interests as claimed in claim 54, wherein said steps of providing said money loan and said listing are provided by a single entity.

60. A method of maximizing financial options as claimed in claim 54, wherein said risk of foreclosure comprises a notice of delinquency.

61. A method of maximizing financial options as claimed in claim 54, wherein said risk of foreclosure comprises a notice of default.

62. A method of maximizing financial options as claimed in claim 54, wherein said foreclosure comprises a notice of trustee sale.

63. A method of maximizing financial options to at least one holder of at least one real property interest, wherein said property interest is at risk of a foreclosure or in foreclosure, the method comprising: a single entity, prior to the sale of said at least one property interest, identifying said real property; appraising said property; and updating the title history of said property.

64. A method of maximizing financial options as claimed in claim 63, further comprising: characterizing the eligibility of said at least one real property interest for a money loan.

65. A method of maximizing financial options as claimed in claim 63, further comprising: listing said at least one real property interest for sale.

66. A method of maximizing financial options as claimed in claim 63, further comprising: providing a money loan to said holder of at least one real property interest, wherein said loan is secured by said at least one real property interest.

67. A method of maximizing financial options to at least one holder of property interests as claimed in claim 63, further comprising: recording a note secured by said at least one real property interest.

68. A method of maximizing financial options to at least one holder of property interests as claimed in claim 63, the method further comprising: providing a money loan and listing said property for sale, wherein said steps are provided by a single entity.

69. A method of maximizing financial options as claimed in claim 63, wherein said risk of foreclosure comprises a notice of delinquency.

70. A method of maximizing financial options as claimed in claim 63, wherein said risk of foreclosure comprises a notice of default.

71. A method of maximizing financial options as claimed in claim 63, wherein said foreclosure comprises a notice of trustee sale.

72. A method of maximizing financial options to at least one holder of at least one real property interest, wherein said property interest is at risk of a foreclosure or in foreclosure, wherein prior to said foreclosure of said at least one real property interest, a single entity performing the steps comprising: identifying said real property, appraising said at least one real property interest, and updating the title history of said at least one real property interest.

73. A method of maximizing financial options as claimed in claim 72, further comprising the step of characterizing the eligibility of said at least one real property interest for a money loan.

74. A method of maximizing financial options as claimed in claim 72, further comprising the step of listing said at least one real property interest for sale.

75. A method of maximizing financial options as claimed in claim 72, further comprising the step of providing a money loan to said holder of at least one real property interest, wherein said loan is secured by said at least one real property interest.

76. A method of maximizing financial options to at least one holder of property interests as claimed in claim 72, further comprising the step of recording a note secured by said at least one real property interest.

77. A method of maximizing financial options to at least one holder of property interests as claimed in claim 72 further comprising the steps of: providing a money loan and listing said property for sale, wherein said steps are provided by a single entity.

78. A method of maximizing financial options as claimed in claim 72, wherein said risk of foreclosure comprises a notice of delinquency.

79. A method of maximizing financial options as claimed in claim 72, wherein said risk of foreclosure comprises a notice of default.

80. A method of maximizing financial options as claimed in claim 72, wherein said foreclosure comprises a notice of trustee sale.
